(19) United States
(12) Patent Application Publication
(10) Pub. No.: US 2024/0248845 A1
(43) Pub. Date: Jul. 25, 2024

(54) SELECTIVELY MIGRATING WRITE DATA BETWEEN CACHES OF DIFFERENT STORAGE SYSTEMS TO PREVENT CACHE OVERDRIVE

(71) Applicant: International Business Machines Corporation, Armonk, NY (US)

(72) Inventors: Gang Lyu, Shanghai (CN); Yao Dong Zhang, Shanghai (CN); Dong Ping Song, Xian (CN); Geng Hu, Xian (CN); Wei Xian, Xian (CN); Ke Qiang Chen, Beijing (CN)

(21) Appl. No.: 18/101,023

(22) Filed: Jan. 24, 2023

(51) Int. Cl. G06F 12/0817; G06F 12/0804; G06F 12/0871

(52) U.S. Cl. CPC G06F 12/0822; G06F 12/0804; G06F 12/0871

(57) ABSTRACT

A computer-implemented method, according to one embodiment, includes obtaining information about a plurality of remote storage systems. Each of the remote storage systems includes a cache. The method further includes generating a routing table based on the information, the routing table indicating potential write data migration paths from a cache of a local storage system to the caches of the remote storage systems. A write data migration plan is generated based on the routing table. The write data migration plan specifies which of the caches of the remote storage systems to migrate at least some write data originally intended to be stored on the cache of the local storage system to. In response to a determination that a first predetermined condition associated with the cache of the local storage system is met, the method includes causing the write data migration plan to be performed.

### BACKGROUND

The present invention relates to storage systems, and more specifically, this invention relates to migrating write data between caches of different storage systems according to a data migration plan in order to prevent cache overdrive.

Non-volatile write cache, e.g., non-volatile storage (NVS), is a partition of main memory space which is protected by a backup power source, e.g., batteries, against a loss of power to store write data to prevent data loss. Non-volatile write cache is typically used by storage systems to support a write back mode to reduce a relative response time of write commands from a host. Non-volatile-write cache includes a finite amount of storage space. Furthermore, only when modified data is de-staged from a Non-volatile write cache, the corresponding space can be released to store the newly arrived write data.

### SUMMARY

A computer-implemented method, according to one embodiment, includes obtaining information about a plurality of remote storage systems. Each of the remote storage systems includes a cache. The method further includes generating a routing table based on the information, the routing table indicating potential write data migration paths from a cache of a local storage system to the caches of the remote storage systems. A write data migration plan is generated based on the routing table. The write data migration plan specifies which of the caches of the remote storage systems to migrate at least some write data originally intended to be stored on the cache of the local storage system to. In response to a determination that a first predetermined condition associated with the cache of the local storage system is met, the method includes causing the write data migration plan to be performed.

A computer program product, according to another embodiment, includes a computer readable storage medium having program instructions embodied therewith. The program instructions are readable and/or executable by a computer to cause the computer to perform the foregoing method.

A system, according to another embodiment, includes a processor, and logic integrated with the processor, executable by the processor, or integrated with and executable by the processor. The logic is configured to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2 is a diagram of a tiered data storage system, in accordance with one embodiment of the present invention.

FIG. 3 is a flowchart of a method, in accordance with one embodiment of the present invention.

FIG. 4 depicts an environment of storage systems, in accordance with one embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for migrating write data between caches of different storage systems according to a data migration plan in order to prevent cache overdrive.

In one general embodiment, a computer-implemented method includes obtaining information about a plurality of remote storage systems. Each of the remote storage systems includes a cache. The method further includes generating a routing table based on the information, the routing table indicating potential write data migration paths from a cache of a local storage system to the caches of the remote storage systems. A write data migration plan is generated based on the routing table. The write data migration plan specifies which of the caches of the remote storage systems to migrate at least some write data originally intended to be stored on the cache of the local storage system to. In response to a determination that a first predetermined condition associated with the cache of the local storage system is met, the method includes causing the write data migration plan to be performed.

In another general embodiment, a computer program product includes a computer readable storage medium having program instructions embodied therewith. The program instructions are readable and/or executable by a computer to cause the computer to perform the foregoing method.

In another general embodiment, a system includes a processor, and logic integrated with the processor, executable by the processor, or integrated with and executable by the processor. The logic is configured to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as migration plan generation module of block 150 for migrating write data between caches of different storage systems according to a data migration plan in order to prevent cache overdrive. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

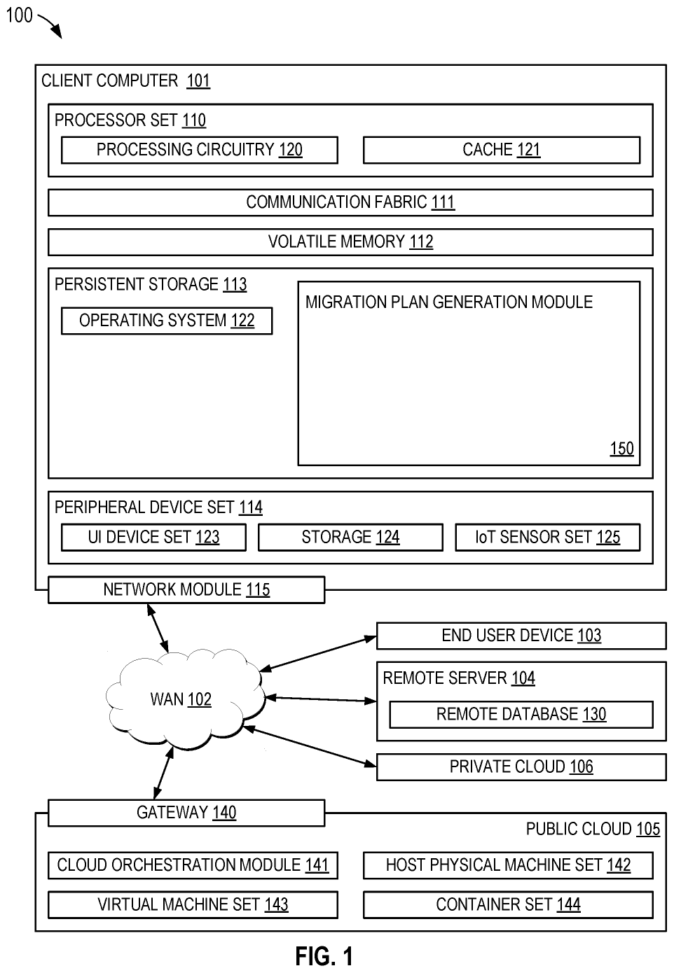

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In some aspects, a system, according to various embodiments, may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

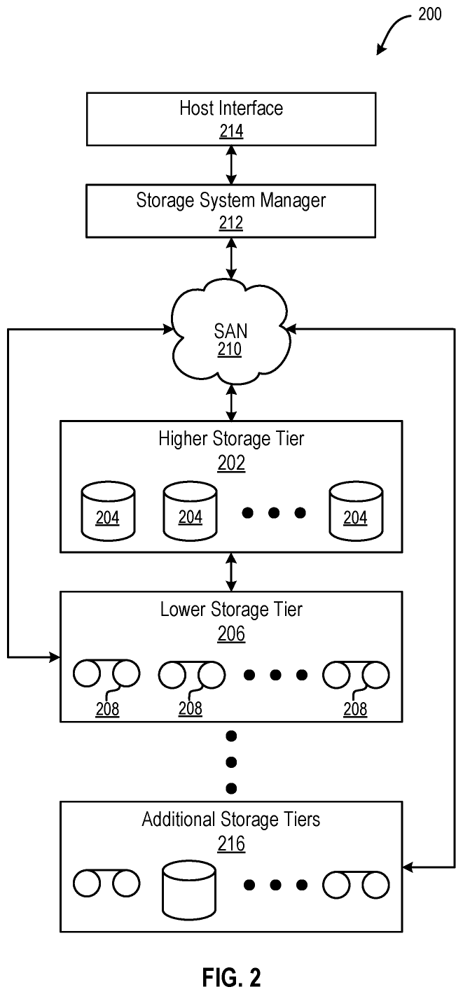

Now referring to FIG. 2, a storage system 200 is shown, according to one embodiment. Note that some of the elements shown in FIG. 2 may be implemented as hardware and/or software, according to various embodiments. The storage system 200 may include a storage system manager 212 for communicating with a plurality of media and/or drives on at least one higher storage tier 202 and at least one lower storage tier 206. The higher storage tier(s) 202 preferably may include one or more random access and/or direct access media 204, such as hard disks in hard disk drives (HDDs), nonvolatile memory (NVM), solid state memory in solid state drives (SSDs), flash memory, SSD arrays, flash memory arrays, etc., and/or others noted herein or known in the art. The lower storage tier(s) 206 may preferably include one or more lower performing storage media 208, including sequential access media such as magnetic tape in tape drives and/or optical media, slower accessing HDDs, slower accessing SSDs, etc., and/or others noted herein or known in the art. One or more additional storage tiers 216 may include any combination of storage memory media as desired by a designer of the system 200. Also, any of the higher storage tiers 202 and/or the lower storage tiers 206 may include some combination of storage devices and/or storage media.

The storage system manager 212 may communicate with the drives and/or storage media 204, 208 on the higher storage tier(s) 202 and lower storage tier(s) 206 through a network 210, such as a storage area network (SAN), as shown in FIG. 2, or some other suitable network type. The storage system manager 212 may also communicate with one or more host systems (not shown) through a host interface 214, which may or may not be a part of the storage system manager 212. The storage system manager 212 and/or any other component of the storage system 200 may be implemented in hardware and/or software, and may make use of a processor (not shown) for executing commands of a type known in the art, such as a central processing unit (CPU), a field programmable gate array (FPGA), an application specific integrated circuit (ASIC), etc. Of course, any arrangement of a storage system may be used, as will be apparent to those of skill in the art upon reading the present description.

In more embodiments, the storage system 200 may include any number of data storage tiers, and may include the same or different storage memory media within each storage tier. For example, each data storage tier may include the same type of storage memory media, such as HDDs, SSDs, sequential access media (tape in tape drives, optical disc in optical disc drives, etc.), direct access media (CD-ROM, DVD-ROM, etc.), or any combination of media storage types. In one such configuration, a higher storage tier 202, may include a majority of SSD storage media for storing data in a higher performing storage environment, and remaining storage tiers, including lower storage tier 206 and additional storage tiers 216 may include any combination of SSDs, HDDs, tape drives, etc., for storing data in a lower performing storage environment. In this way, more frequently accessed data, data having a higher priority, data needing to be accessed more quickly, etc., may be stored to the higher storage tier 202, while data not having one of these attributes may be stored to the additional storage tiers 216, including lower storage tier 206. Of course, one of skill in the art, upon reading the present descriptions, may devise many other combinations of storage media types to implement into different storage schemes, according to the embodiments presented herein.

According to some embodiments, the storage system (such as 200) may include logic configured to receive a request to open a data set, logic configured to determine if the requested data set is stored to a lower storage tier 206 of a tiered data storage system 200 in multiple associated portions, logic configured to move each associated portion of the requested data set to a higher storage tier 202 of the tiered data storage system 200, and logic configured to assemble the requested data set on the higher storage tier 202 of the tiered data storage system 200 from the associated portions.

Of course, this logic may be implemented as a method on any device and/or system or as a computer program product, according to various embodiments.

As mentioned elsewhere herein, non-volatile write cache, e.g., NVS, is a partition of main memory space which is protected by a backup power source, e.g., batteries, against a loss of power to store write data to prevent data loss. Non-volatile write cache is typically used by storage systems to support a write back mode to reduce a relative response time of write commands from a host. Non-volatile-write cache includes a finite amount of storage space. Furthermore, only when modified data is de-staged from a non-volatile write cache, the corresponding space can be released to store the new arrived write data. However, in some cases, the rate at which write data arrives exceeds a rate at which data is cached, thereby causing the non-volatile write cache to “overdriven” based on there being a bottleneck in which the new arrived host write commands wait in a buffer of a host adapter without write completion returning to the host. Accordingly, the response time of the write command being performed can become relatively very long, or in some cases the host may even lose the access if its threshold is exceeded. Accordingly, there is a longstanding need for addressing non-volatile write cache overdrive in storage systems in order to mitigate the performance compromising issues described above. Conventional techniques have been unable to meet or even address this longstanding need.

In sharp contrast to the deficiencies of the conventional techniques described above, various embodiments and approaches described herein prevent overdrive of a cache of a local storage system by generating a write data migration plan based on a routing table, where the write data migration plan specifies which cache of remote storage systems to migrate at least some write data originally intended to be stored on the cache of the local storage system to. Furthermore, the embodiments and approaches described herein enable sharing of write cache of main memory across storage systems to prevent write cache overdrive and balance performance. In some embodiments and/or approaches, least recently used write data and sequential write data are migrated to the write cache of remote systems in response to a determination that the write cache of local systems are overdriven, which thereby decreases the impact of the write response time to a host. Furthermore, a data migration plan and routing table are preferably generated according to the predicted write workload, predicted available write cache size and/or predicted write response time. In some preferred approaches, a feedback mechanism is enabled to refine the parameters in each iteration performing one or more operations described herein, e.g., see method 300.

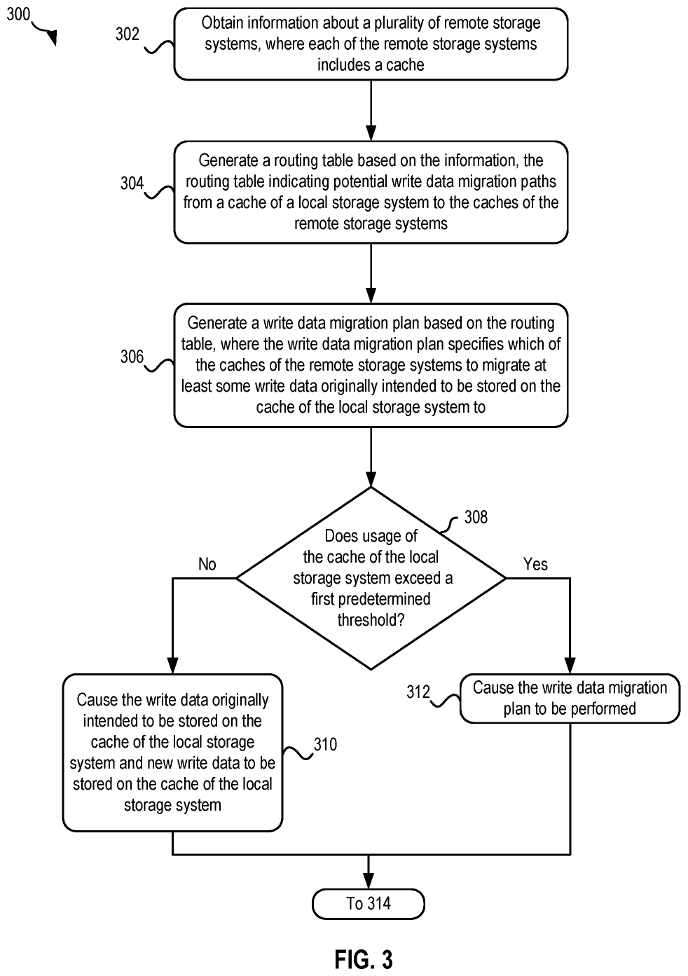

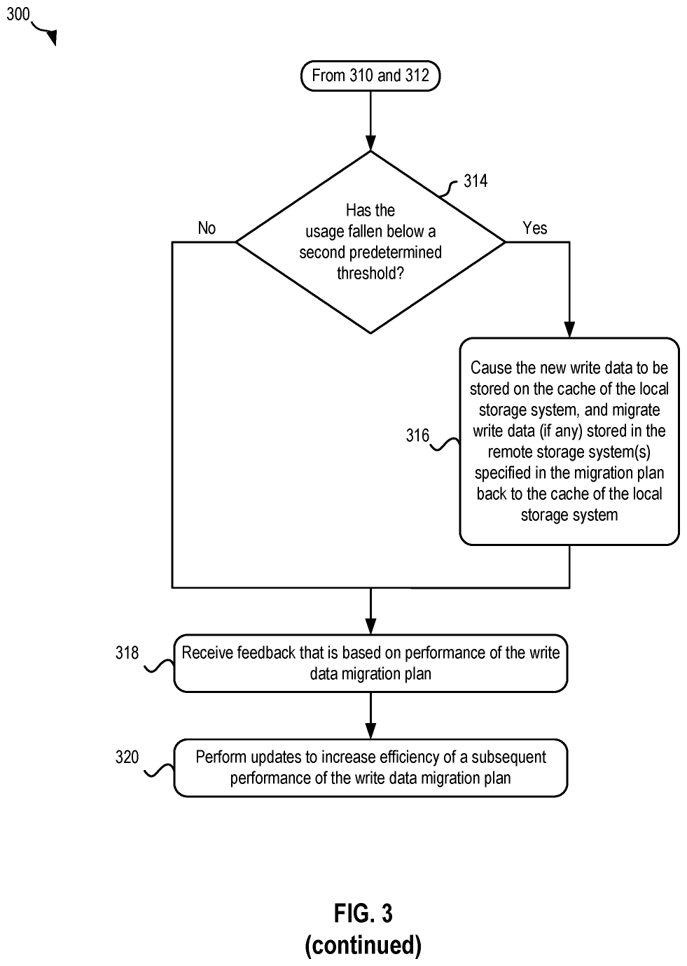

Now referring to FIG. 3, a flowchart of a method 300 is shown, according to one embodiment. The method 300 may be performed in accordance with the present invention in any of the environments depicted in FIGS. 1-4, among others, in various embodiments. Of course, more or fewer operations than those specifically described in FIG. 3 may be included in method 300, as would be understood by one of skill in the art upon reading the present descriptions.

Each of the steps of the method 300 may be performed by any suitable component of the operating environment. For example, in various embodiments, the method 300 may be partially or entirely performed by a computer, or some other device having one or more processors therein. The processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

It may be prefaced that method 300 may be performed in an environment that includes a plurality of storage systems. In some approaches, one or more of such storage systems may include host agents that are in communication with one or more hosts, which may be outside of the storage system. The host agents may be in communication with one or more controllers. In some approaches, at least one of the controllers may include a processor and a main memory. The main memory preferably includes a cache and/or NVS. Each of the one or more controllers may be in communication with one or more Redundant Array of Independent Disks (RAID) controllers, and the RAID controllers may in some approaches be in communication with a storage pool that includes a RAID array of disks.

It should also be prefaced that various “storage systems” are described in method 300 and other embodiments described herein, e.g., see “local storage system” and “remote storage system.” Although referred to as “storage system(s)” herein, these storage systems may also be referred to as “nodes” and/or machines and/or devices and/or components thereof, which may be of a known type, in other environments. Accordingly, although various embodiments and approaches described herein are described with respect to “storage system(s),” these embodiments and approaches are also enabled for nodes and/or machines. It may also be noted that although various embodiments and approaches described herein refer to a “local storage system” and a plurality of “remote storage systems,” in some approaches, the “local storage system” may be the storage system that various operations of method 300 are performed, e.g., selective migrations are performed from cache of the local storage system to cache(s) of one or more of the remote storage systems in order to prevent overdrive on the cache of the local storage system. Furthermore, such storage systems may or may not be necessarily remote and local with respect to one another, e.g., reside at different geographical locations, reside at the same geographical location, etc. However, the method may additionally and/or alternatively be performed for preventing overdrive on a cache of at least one of the remote storage systems.

According to one example, operations performed with respect to a “local storage system” may, in other approaches, be performed with respect to a “master node.” Furthermore, in another example, information received from a “remote storage system” may, in some other approaches, be received from a “subordinate node.” In some approaches in which nodes are considered, the two or more master nodes, e.g., for relatively high availability, may be used to run a write cache clustering controller component to manage the operations of all the subordinate nodes. Components used may additionally and/or alternatively include a write cache clustering controller. Each of the subordinate nodes may run a write cache clustering agent to communicate with the write cache clustering controller in the master nodes. Component used for performing one or more operations of method 300 may additionally and/or alternatively include a write cache clustering agent, a performance monitor component, a prediction controller, etc., where one or more of such components may be of a type that would become appreciated to one of ordinary skill in the art upon reading the descriptions herein.

In some approaches, method 300 includes initializing the storage systems. For example, in some approaches, such initialization may include launching a write cache clustering controller in a local storage system, e.g., the master node. In some approaches, the initialization may additionally and/or alternatively include launching write cache clustering agent(s), performance monitor(s) and prediction controller(s) in one or more of the remote storage systems, e.g., subordinate nodes.

Initialization of the storage systems may, in some approaches, additionally and/or alternatively include setting values of one or more parameters of the storage systems. For example, the initialization may include setting maximum write cache thresholds for the storage systems, e.g., a Max WriteCacheSize(i), which may be a unique threshold for each of the storage systems, e.g., the local storage system and the remote storage systems. One or more thresholds for triggering migration of write operations from the local storage system to the remote storage system and/or vice versa may additionally and/or alternatively be set. For example, a first predetermined threshold, e.g., UseRemoteCacheThreshold(i), and/or a second predetermined threshold, e.g., UseRemoteCacheThreshold2(i), may be set for every node to use remote write cache. Depending on the approach, such predetermined thresholds, e.g., UseRemoteCacheThreshold(i), can be set to a percentage, an absolute value, etc. Note that such predetermined thresholds will be described in greater detail elsewhere herein, e.g., see use of such predetermined thresholds in decision 308 through operation 316 in one approach.

It may also be prefaced that various operations of method 300 are performed with respect to predetermined amounts of time. For example, in some approaches, operations may be performed with respect to predetermined times slots, that each include a predetermined amount of time in which the storage systems operate. More specifically, in some approaches, such operations may be performed for a next time slot (n+1) of operation of the storage systems that immediately follows a current time slot (n) of operation of the storage systems. Accordingly, in some approaches, the initialization of the storage systems may additionally and/or alternatively include setting a size of the time slot(s). Note that, in some preferred approaches, each of the time slots include the same amount of time.

Operation 302 includes obtaining information about a plurality of remote storage systems, e.g., a cluster of remote storage systems. In some approaches, the information is obtained based on being received from one or more of the remote storage systems. In another approach, the information may additionally and/or alternatively be obtained based on a query being issued, e.g., from the local storage system to one or more of the remote storage systems. In yet another approach, the information may additionally and/or alternatively be obtained by accessing a predetermined table in which the information is stored.

In some approaches, the information is received by the local storage system, e.g., such as in one or more approaches in which operations of method 300 are performed by a component, e.g., a computer or some other processing device, of the local storage system. In contrast, in some other approaches, the information may be received by a component outside of the storage systems, that is in communication with one or more of the storage systems and/or configured to perform one or more of the operations of method 300.

As indicated elsewhere above, in some preferred approaches, each of the storage systems includes a cache. In some approaches, the caches of the storage systems described in method 300 may be non-volatile write caches (Non-volatile storage, NVS) of memory and/or cache of main memory of a controller which may include the main memory and additionally and/or alternatively potentially include one or more processors.

The obtained information may be used for one or more predetermined calculations that are then incorporated into a routing table. For example, in some approaches, a routing table may be generated based on the information, and the routing table may indicate potential write data migration paths from a cache of a local storage system to the caches of the remote storage systems, e.g., see operation 304. The calculations may be performed for a next time slot, e.g., “n+1”, of operation of the storage systems that immediately follows a current time slot, of operation of the storage systems, in some approaches. Accordingly, in some approaches, the information may be historical data that is based on the current time slot of operation of the storage systems and/or previous time slot(s) of operation of the storage systems. Various calculations that may be performed and incorporated into generation of the routing table are described below.

In some preferred approaches, the routing table is generated based a calculation, e.g., where the obtained information is used as values for the performed calculations, that includes predicted write workloads of the caches of the remote storage systems. Note that, in some approaches, the calculations are more specifically called “predictions” because they may be based on historical data in previous time slots to predict an expectation in a next time slot. Accordingly, in some approaches, the obtained information is used to calculate predicted write workloads of the caches of the remote storage systems for a next time slot (n+1). A prediction controller may, in some approaches, use the historical data in the previous time slots to predict the expectation in the next time slot. Different prediction methods may be used in different approaches. For example, exponential moving average (EMA) techniques may be used in some approaches. An illustrative equation that may be used for determining the EMA may include:

$$EMA\_n = ( 1 - α ) * EMA\_n + α * Data\_n + 1 \qquad Equation ( 1 )$$

where, “n+1” is a next time slot, “n” is a time slot before the next time slot, and “a” is a predetermined value.

The obtained information may additionally and/or alternatively be used to calculate predicted sizes of available write resources of the caches of the remote storage systems, e.g., for a next time slot. In some approaches, the expected write workload for a given remote storage system may be determined from the obtained information, e.g., based on reviewing scheduled workloads of the remote storage system, based on reviewing and determining an average of workloads previously performed by the remote storage system, etc. In some approaches, to calculate the expected write workload for a given remote storage system, an agent may be caused, e.g., instructed, to acquire a historical write workload of the given remote storage system from a predetermined performance monitor that is configured to collect such information. The agent may, in some approaches, be caused to invoke a prediction controller to predict the workload in the next time slot (n+1). In some approaches, the agent in each remote storage system may send the predicted workload of remote storage system to a controller of the local storage system, e.g., in the obtained information.

In some approaches, the obtained information may additionally and/or alternatively be used to calculate predicted available write cache size of the caches of the remote storage systems. In some approaches, the available write cache size for a given remote storage system may be determined from the obtained information, e.g., based on reviewing scheduled workloads of the remote storage system, based on reviewing and determining an average of a write cache size previously available on the remote storage system, etc. Calculating the expected available write cache size of a given one of the remote storage systems may additionally and/or alternatively include an agent of the remote storage system and/or the local storage system acquiring a historically used write cache size of the given remote storage system, e.g., from the predetermined performance monitor. In such an approach, the agent may invoke a prediction controller to predict the used write cache size in the next time slot (time slot n+1, node i), and the equation below may be used to make such a prediction.

$$AvailableCacheSize ( i , n + 1 ) = MaxWriteCacheSize ( i ) - UsedWriteCacheSize ( i , n + 1 ) \qquad Equation ( 2 )$$

In response to a determination that the AvailableCacheSize(i, n+1)>0, the write cache of AvailableCacheSize(i, n+1) may optionally be added into the write cache cluster. In some approaches, agents of the remote storage systems may send the available write cache sizes to a controller in the local storage system.

In some approaches, the obtained information may additionally and/or alternatively be used to calculate latencies, e.g., response times, each associated with use of a different one of the potential write data migration paths, e.g., from the cache of the local storage system to the caches of the remote storage systems. In some approaches, the latency associated with a migration path from the local storage system to a first of the remote storage systems may be calculated based on the obtained information. For example, the information may include a historical average of write data transmission latency from the local storage system to the first remote storage system, which may be information obtained from the performance monitor. If no workload is available for some storage system pairs, e.g., the pair of the local storage system and the first remote storage system, a relatively very small test workload of a predetermined size may be sent between the pairs and a resulting latency may be recorded to establish the information. In one approach, this test may be performed by causing, e.g., instructing, the performance monitor to trigger such a test. An agent may invoke a prediction controller to predict average write data transmission latency from the local storage system to the remote storage systems in the next time slot (n+1), e.g., Latency (i, j, n+1): from local storage system (i) to remote storage system (j) in the time slot (n+1). In some approaches, an agent in each remote storage system may send an associated write latency to a controller in the local storage system, e.g., in the obtained information.

The routing table may, in some approaches, be generated by a predetermined controller. In some approaches, the routing table may be generated using crossing-node latency as weights. Different methods, such as shortest path first (SPF), may additionally and/or alternatively be used to generate the routing table.

Operation 306 includes generating a write data migration plan based on the routing table. The write data migration plan preferably specifies which of the caches of the remote storage systems to migrate at least some write data originally intended to be stored on the cache of the local storage system to. Note that the write data migration plan may be generated based on the routing table, and therefore the generation of the write data migration plan may additionally and/or alternatively be based on the obtained information and/or one or more of the calculations described above for generating the routing table.

With the write data migration plan established, monitoring may be performed to determine whether to initiate performance of the write data migration plan. In some approaches, known monitoring techniques may be performed to determine whether one or more conditions are met in order to determine whether to perform the write data migration plan. For example, it may be determined whether the cache of the local storage system, and more specifically usage of the write cache of the local storage system, exceeds a first predetermined threshold, e.g., see decision 308. Note that the first predetermined threshold is described elsewhere herein as “UseRemoteCacheThreshold(i).” In response to a determination that a first predetermined condition associated with the cache of the local storage system is met, e.g., as illustrated by the “Yes” logical path of decision 308, method 300 includes causing, e.g., instructing, the write data migration plan to be performed, e.g., see operation 312. Causing the write data migration plan to be performed, in some approaches, includes migrating the at least some of the write data originally intended to be stored on the cache of the local storage system to remote storage system(s) specified in the write data migration plan. In contrast, in response to a determination that the first predetermined condition is not met and/or that the usage falls below the first predetermined threshold subsequent to a determination that the usage of the write cache of the local storage system exceeds the first predetermined threshold, e.g., as illustrated by the “No” logical path of decision 308, method 300 includes causing the write data originally intended to be stored on the cache of the local storage system, e.g., see operation 310. New write data may additionally and/or alternatively be caused to be stored on the cache of the local storage system in response to the determination that the first predetermined condition is not met and/or in response to the determination that the usage falls below the first predetermined threshold subsequent to a determination that the usage of the write cache of the local storage system exceeds the first predetermined threshold, e.g., see operation 310. In some approaches, the one or more conditions may be determined to be potentially met based on a second predetermined threshold. For example, it may be determined whether the usage of the write cache of the local storage system has fallen below a second predetermined threshold, e.g., see decision 314. Note that the second predetermined threshold is described elsewhere herein as “UseRemoteCacheThreshold2(i).”

In response to a determination that the usage of the write cache of the local storage system falls below the second predetermined threshold, e.g., as illustrated by the “Yes” logical path of decision 314, the new write data may be caused to be stored on the cache of the local storage system, e.g., see operation 316. In some approaches, data stored in the remote storage system(s) specified in the write data migration plan as a result of performance of the write data migration plan in response to a determination that the first predetermined threshold was exceeded may be migrated back to the cache of the local storage system in response to a determination that the usage of the write cache of the local storage system falls below the second predetermined threshold, e.g., see operation 316. This thereby enables sharing of the write cache of main memory across systems to prevent write cache overdrive and balance performance. This improves performance of computer devices associated with the storage of write data, because overdrive of caches is prevented. Furthermore, operations that include migrating write data back to the cache of the local storage system is optionally held off until cache resources of the local storage system are readily available, e.g., as characterized by the second predetermined threshold.

In some approaches, generating the write data migration plan may include causing, e.g., instructing, a controller, a processor, a computer, etc., to use the expected write workload and expected available write cache size of every remote storage system to search the routing table. One or more of the remote storage systems having caches determined to have a relatively smallest write latency with respect to the local storage system may be determined from the routing table and incorporated into the write data migration plan for the local storage system. In some approaches, it may be determined that the available write cache of a given remote storage system cache is not enough to store a predetermined amount of write data. In response to the determination that the available write cache of a given remote storage system cache is not enough to store a predetermined amount of write data, another remote storage system, e.g., a next remote storage system, may be selected for the write data migration plan. In some approaches, in response to the determination that the available write cache of a given remote storage system cache is not enough to store a predetermined amount of write data, the write data may be divided to be stored on the caches of two or more of the remote storage systems, e.g., such as the caches of two or more of the remote storage systems determined from the routing table to have a relatively lowest amount of latency with respect to the local storage system. For context, the write data migration plan establishes one or more target caches of target remote storage systems for the write data migration. In some approaches, the write data migration plan may be output to each of the remote storage systems and/or the local storage system so that a write data migration plan is understood for a next time slot, e.g., in the event that such a migration plan is needed to be performed to avoid cache overdrive.

As mentioned elsewhere herein, in some optional approaches, the write data migration plan considers a migration plan for each of the storage systems, e.g., the local storage system and the remote storage systems, in order to prevent overdrive from occurring on any of the caches of the storage systems. Accordingly, in some approaches, the write data migration plan may additionally and/or alternatively be generated to specify where at least some write data originally intended to be stored on the cache of a first of the remote storage systems are migrated to. In one or more of such approaches, in response to a determination that a first predetermined condition associated with the cache of the first remote storage system is met, the write data migration plan may be caused, e.g., instructed, to be performed. The predetermined condition associated with the cache of the first remote storage system may be any one or more of the predetermined conditions mentioned elsewhere herein. For example, the write data migration plan may specify that the at least some write data originally intended to be stored on the cache of the first remote storage systems are to be migrated to the cache of the local storage system in response to a determination that the first predetermined condition associated with the cache of the first remote storage system is met. Accordingly, a write data migration plan may be generated, e.g., by a predetermined controller, for every storage system, and the write data migration plan may be output to agents of each of the storage systems so that a write data migration plan is understood for a next time slot, e.g., in the event that such a migration plan is needed to be performed to avoid cache overdrive.

It should be noted that, in some approaches, not all write data that is queued and/or originally intended to be stored on the cache of the local storage system may be migrated to the cache(s) of the remote storage systems during performance of the write data migration plan. For example, in some approaches, a predefined subset of the write data that is queued and/or originally intended to be stored on the cache of the local storage system may be migrated to the cache(s) of remote storage systems may only need to be migrated in order to prevent overdrive of the cache of the local storage system. Various examples of types of write data that may be prioritized for migrating first to the cache(s) of the remote storage systems during performance of the write data migration plan are described below.

In some approaches, least recently used (LRU) write data and/or sequential write data may be migrated to the specified caches of the remote storage systems as a result of the write data migration plan being performed. This may be achieved by migrating at least some write data to the caches of the remote storage systems specified in the write data migration plan. In some other approaches, a workload choice for migration of write data to the cache of a remote storage system may include an agent redirecting the to-be-destaged least recently used data from a predetermined cache/page replacement method, to predetermined space of cache(s) of one or more of the remote storage systems. For example, in some approaches, a redirect the to-be-destaged data of wise ordering for Writes (WOW) method in DS8K by IBM may be performed to one or more of the remote storage systems. In some approaches in which the LRU data are migrated to one or more remote storage systems, the latency dependency of every write stream may be judged and the sequential write data may be migrated to the remote storage system(s). According to a more specific approach, for the write data to address k, the dependency to the response time/latency may be LatencyDependency (k, n+1). In some approaches, this process may be simplified to consider the randomness of the data. It should be noted that typically, the response time/latency may be considered more important to random data compared with sequential data. The randomness of every write stream may be judged, and in some approaches, a different method may be used to judge the randomness. For example, the sequential write data may be redirected to the sequential LRU list to the remote storage system.

In some approaches, parameters method 300 may include refining and/or optimizing parameters described herein. This may be enabled as a result of feedback, e.g., overdrive occurrences, threshold exceeding occurrences, usage information, etc., that is based on performance of the write data migration plan being received, e.g., see operation 318. Such feedback may be of a type that would become appreciated to one of ordinary skill in the art upon reading the descriptions herein. Updates may be performed to increase efficiency of a subsequent performance of the write data migration plan, e.g., see operation 320. In some approaches, the updates may include adjusting parameters such as a size of time slots of operation of the storage systems, e.g., a next time slot. Parameters that may be adjusted may additionally and/or alternatively include the predetermined condition, e.g., such as the maximum write cache threshold. The routing table and/or the write data migration plan may be re-generated subsequent to the updates being performed. This feedback may establish more and more accumulated historical data to be incorporated into the prediction of a next time slot, workload, cache sizing, etc.

Numerous benefits are enabled as a result of implementing the techniques of various embodiments and approaches described herein. For example, performance is increased as a result of decreasing and/or avoiding the overdrive of write cache. Therefore, the performance degradation of host write workload is decreased and/or avoided. Furthermore, full advantage is taken of free space in the write cache of main memory for the storage systems in the same site, e.g., of the cluster of the remote and local storage systems. As a result of this, the total cost of ownership (TCO) of customers also decreases. The response time increase of the host write commands for the write data migration is also minimized. These techniques may be applied to known types of storage servers, e.g., such as DS8K by IBM, host servers such as IBM Power, etc. It should also be noted that memory clustering does not enable detection of and prevention of overdrive of cache of main memory of a storage system. However, in some approaches, using the techniques described herein, potential migration paths are established and memory clustering information may be used to migrate the cache writes in response to a determination that a first predetermined condition associated with the cache of main memory of the local storage system is met.

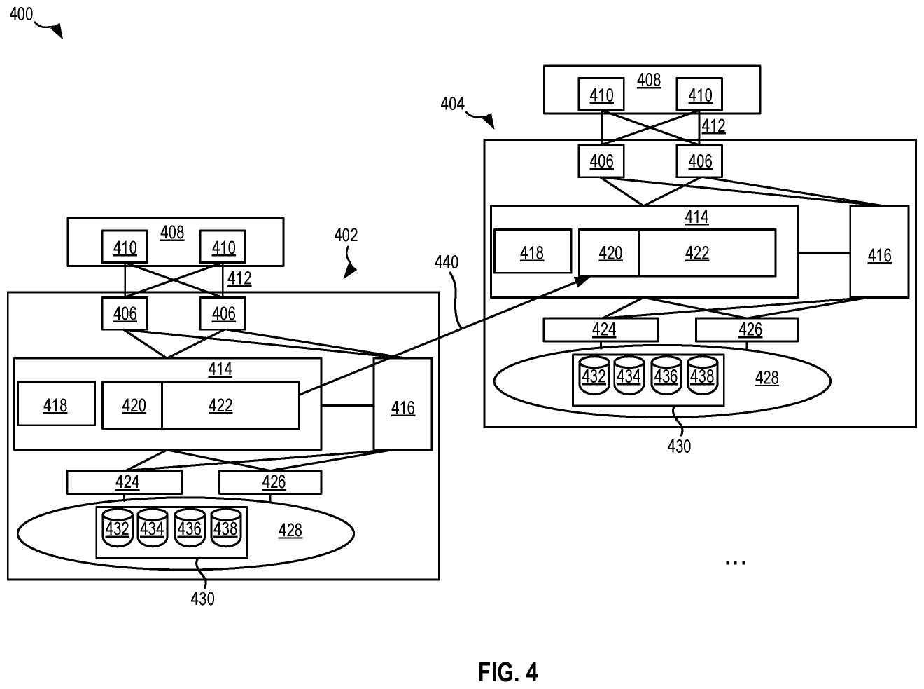

FIG. 4 depicts an environment 400 of storage systems, in accordance with one embodiment. As an option, the present environment 400 may be implemented in conjunction with features from any other embodiment listed herein, such as those described with reference to the other FIGS. Of course, however, such environment 400 and others presented herein may be used in various applications and/or in permutations which may or may not be specifically described in the illustrative embodiments listed herein. Further, the environment 400 presented herein may be used in any desired environment.

The environment 400 includes a plurality of storage systems. For example, the environment 400 includes a local storage system 402 and a remote storage system 404, although the environment 400 may include a plurality of other storage systems, e.g., additional remote storage systems noted by “ . . . ”. The storage systems may include host agents 406, and hosts 408, which may be outside of the storage systems, that include host bus adapters 410 that are in communication with the host adapters via a storage area network (SAN) 412. The host agents may be in communication with one or more controllers, e.g., see controllers 414 and 416. In some approaches, at least one of the controllers may include a processor 418 and a main memory, e.g., see main memory that includes a cache 422 and/or NVS 420. Each of the one or more controllers may be in communication with one or more RAID controllers 424 and 426, and the RAID controllers may, in some approaches, be in communication with a storage pool 428 that includes a RAID array 430 of disks 432, 434, 436 and 438. A routing table may be generated based on obtained information, where the routing table indicates potential write data migration paths from the cache of the local storage system 402 to the caches of the remote storage systems “ . . . ” and 404. A write data migration plan may be generated based on the routing table, and the write data migration plan may specify which of the caches of the remote storage systems to migrate at least some write data originally intended to be stored on the cache of the local storage system to. In response to a determination that a first predetermined condition associated with the cache of the local storage system is met, the write data migration plan may be caused to be performed. Performing the write data migration plan may include causing at least some write data originally intended to be stored on the cache of the local storage system to be migrated to the cache of the remote storage system 404, e.g., see operation 440.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
obtaining information about a plurality of remote storage systems, wherein each of the remote storage systems includes a cache;
generating a routing table based on the information, the routing table indicating potential write data migration paths from a cache of a local storage system to the caches of the remote storage systems;
generating a write data migration plan based on the routing table, wherein the write data migration plan specifies which of the caches of the remote storage systems to migrate at least some write data originally intended to be stored on the cache of the local storage system to; and
in response to a determination that a first predetermined condition associated with the cache of the local storage system is met, causing the write data migration plan to be performed.

2. The computer-implemented method of claim 1, wherein the routing table and the write data migration plan are generated based on calculations selected from the group consisting of: predicted write workloads of the caches of the remote storage systems, predicted sizes of available write resources of the caches of the remote storage systems, predicted available write cache size of the caches of the remote storage systems, and latencies each associated with use of a different one of the potential write data migration paths.

3. The computer-implemented method of claim 2, wherein the calculations are performed for a next time slot of operation of the storage systems that immediately follows a current time slot of operation of the storage systems, wherein the information includes historical data that is based on the current time slot of operation of the storage systems and/or previous time slot(s) of operation of the storage systems.

4. The computer-implemented method of claim 1, wherein the first predetermined condition includes usage of the cache of the local storage system exceeding a first predetermined threshold, wherein causing the write data migration plan to be performed includes migrating the at least some write data originally intended to be stored on the cache of the local storage system to remote storage system(s) specified in the write data migration plan, and comprising: in response to a determination that the first predetermined condition is not met and/or that the usage falls below the first predetermined threshold, causing the at least some write data originally intended to be stored on the cache of the local storage system and new write data to be stored on the cache of the local storage system; and in response to a determination that the usage falls below a second predetermined threshold: causing the new write data to be stored on the cache of the local storage system, and migrating data stored in the remote storage system(s) specified in the write data migration plan back to the cache of the local storage system.

5. The computer-implemented method of claim 1, wherein least recently used write data and sequential write data are migrated to the specified caches of the remote storage systems as a result of the write data migration plan being performed.

6. The computer-implemented method of claim 1, comprising: receiving feedback that is based on performance of the write data migration plan; performing updates to increase efficiency of a subsequent performance of the write data migration plan, wherein the updates are selected from the group consisting of: adjusting a size of time slots of operation of the storage systems, and adjusting the predetermined condition; and re-generating the routing table and/or the write data migration plan subsequent to the updates being performed.

7. The computer-implemented method of claim 1, wherein the write data migration plan specifies where to migrate the at least some write data originally intended to be stored on the cache of a first of the remote storage systems, and comprising: in response to a determination that a first predetermined condition associated with the cache of the first remote storage system is met, causing the write data migration plan to be performed.

8. The computer-implemented method of claim 7, wherein the write data migration plan specifies that the at least some write data originally intended to be stored on the cache of the first remote storage systems are to be migrated to the cache of the local storage system in response to a determination that the first predetermined condition associated with the cache of the first remote storage system is met.

9. The computer-implemented method of claim 1, wherein the cache of the local storage system is a non-volatile write cache, wherein the caches of the remote storage systems are non-volatile write caches.

10. A computer program product, the computer program product comprising a computer readable storage medium having program instructions embodied therewith, the program instructions readable and/or executable by a computer to cause the computer to:
obtain, by the computer, information about a plurality of remote storage systems, wherein each of the remote storage systems includes a cache;
generate, by the computer, a routing table based on the information, the routing table indicating potential write data migration paths from a cache of a local storage system to the caches of the remote storage systems;
generate, by the computer, a write data migration plan based on the routing table, wherein the write data migration plan specifies which of the caches of the remote storage systems to migrate at least some write data originally intended to be stored on the cache of the local storage system to; and
in response to a determination that a first predetermined condition associated with the cache of the local storage system is met, cause, by the computer, the write data migration plan to be performed.

11. The computer program product of claim 10, wherein the routing table and the write data migration plan are generated based on calculations selected from the group consisting of: predicted write workloads of the caches of the remote storage systems, predicted sizes of available write resources of the caches of the remote storage systems, predicted available write cache size of the caches of the remote storage systems, and latencies each associated with use of a different one of the potential write data migration paths.

12. The computer program product of claim 11, wherein the calculations are performed for a next time slot of operation of the storage systems that immediately follows a current time slot of operation of the storage systems, wherein the information includes historical data that is based on the current time slot of operation of the storage systems and/or previous time slot(s) of operation of the storage systems.

13. The computer program product of claim 10, wherein the first predetermined condition includes usage of the cache of the local storage system exceeding a first predetermined threshold, wherein causing the write data migration plan to be performed includes migrating the at least some write data originally intended to be stored on the cache of the local storage system to remote storage system(s) specified in the migration plan, and the program instructions readable and/or executable by the computer to cause the computer to: in response to a determination that the first predetermined condition is not met and/or that the usage falls below the first predetermined threshold, cause, by the computer, the at least some write data originally intended to be stored on the cache of the local storage system and new write data to be stored on the cache of the local storage system; and in response to a determination that the usage falls below a second predetermined threshold: cause, by the computer, the new write data to be stored on the cache of the local storage system, and migrate, by the computer, data stored in the remote storage system(s) specified in the write data migration plan back to the cache of the local storage system.

14. The computer program product of claim 10, wherein least recently used write data and sequential write data are migrated to the specified caches of the remote storage systems as a result of the write data migration plan being performed.

15. The computer program product of claim 10, the program instructions readable and/or executable by the computer to cause the computer to: receive, by the computer, feedback that is based on performance of the write data migration plan;
perform, by the computer, updates to increase efficiency of a subsequent performance of the write data migration plan, wherein the updates are selected from the group consisting of: adjusting a size of time slots of operation of the storage systems, and adjusting the predetermined condition; and re-generate, by the computer, the routing table and/or the write data migration plan subsequent to the updates being performed.

16. The computer program product of claim 10, wherein the write data migration plan specifies where to migrate the at least some write data originally intended to be stored on the cache of a first of the remote storage systems, and the program instructions readable and/or executable by the computer to cause the computer to:
in response to a determination that a first predetermined condition associated with the cache of the first remote storage system is met, cause, by the computer, the write data migration plan to be performed.

17. The computer program product of claim 16, wherein the write data migration plan specifies that the at least some write data originally intended to be stored on the cache of the first remote storage systems are to be migrated to the cache of the local storage system in response to a determination that the first predetermined condition associated with the cache of the first remote storage system is met.

18. The computer program product of claim 10, wherein the cache of the local storage system is a non-volatile write cache, wherein the caches of the remote storage systems are non-volatile write caches.

19. A system, comprising:
a processor; and
logic integrated with the processor, executable by the processor, or integrated with and executable by the processor, the logic being configured to:
obtain information about a plurality of remote storage systems, wherein each of the remote storage systems includes a cache;
generate a routing table based on the information, the routing table indicating potential write data migration paths from a cache of a local storage system to the caches of the remote storage systems;
generate a write data migration plan based on the routing table, wherein the write data migration plan specifies which of the caches of the remote storage systems to migrate at least some write data originally intended to be stored on the cache of the local storage system to; and
in response to a determination that a first predetermined condition associated with the cache of the local storage system is met, cause the write data migration plan to be performed.

20. The system of claim 19, wherein the routing table and the write data migration plan are generated based on calculations selected from the group consisting of:
predicted write workloads of the caches of the remote storage systems, predicted sizes of available write resources of the caches of the remote storage systems, predicted available write cache size of the caches of the remote storage systems, and latencies each associated with use of a different one of the potential write data migration paths.
